(19) United States
(12) Patent Application Publication
(10) Pub. No.: US 2015/0026624 A1
(43) Pub. Date: Jan. 22, 2015

(54) METHODS AND SYSTEMS FOR DEFORMABLE THUMB KEYBOARD

(71) Applicant: QUALCOMM Incorporated, San Diego, CA (US)

(72) Inventors: Shiu Wai Hui, Richmond Hill, CA (US); Veluppillai Arulesan, Toronto, CA (US)

(21) Appl. No.: 13/943,260

(22) Filed: Jul. 16, 2013

(51) Int. Cl. G06F 3/0488

(52) U.S. Cl. CPC G06F 3/04886
USPC 715/773

(57) ABSTRACT

Systems and methods are disclosed for deformable thumb keyboards on the touchscreens of mobile devices to enable users to use the thumb of the same hand that is holding a mobile device to type on the keyboard of the mobile device. Users may enter a keyboard configuration mode of the mobile device to create and fine tune the thumb keyboard. To create a thumb keyboard, users may sketch an arc on the touchscreen to define a general outline of the keyboard. Users may manipulate the shape, size, location, layout, etc., of the thumb keyboard on the touchscreen to fit the users' preferences. For example, a right-handed user may customize a thumb keyboard in an arc region along the lower right corner of the touch screen to allow the right thumb of the user easy access to all the keys when holding the mobile device in the right hand.

### TECHNICAL FIELD

This application generally relates to touch screen devices. In particular, this application relates to methods and systems for configuring and displaying on-screen keyboards for thumb typing on touch screen devices.

### BACKGROUND

Mobile devices such as smartphones are becoming ubiquitous. Increasingly, people are relying on their smartphone as their sole personal computing and communication device. One reason for the smartphones' popularity is the touch screen user interface which affords users an intuitive and easy-to-use interface for entering commands. For example, smartphones may display an on-screen keyboard for users to type in uniform resource locators (URLs) of webpages, compose emails/text messages, or otherwise enter commands into programs or apps. Conventionally, typing on keyboards of mobile devices requires a user to use both hands. For example, users may hold a smartphone with one hand and type with the other hand. Alternatively, users may hold the smartphone with both hands, and type with the thumbs of both hands.

However, users on the move may not always have both hands free. Frequently, users may have to hold a smartphone in the palm of one hand and type with the thumb of the same hand. The problem with thumb typing using the smartphone-holding hand on a conventional on-screen keyboard is that the keyboard may be spread out over the screen, making it difficult for users to hold the smartphone and reach all the keys with the same hand. Indeed, it may be nearly impossible for users to reach keys furthest from the thumb without having to reposition the smartphone in their hand, making typing cumbersome and increasing chances for the users to accidentally drop the smartphone. As such, there is a need for a solution to enable users to easily type on the keyboard of a smartphone while holding the smartphone with the same hand.

### SUMMARY

Systems and methods are disclosed for a deformable thumb keyboard on the touchscreen of a mobile device to enable users to type on the keyboard using the thumb of the same hand that is holding the mobile device. Users may conveniently use one hand to compose e-mails/text messages, enter website URLs, or type commands into the mobile devices. Users may define the size, location, and the layout of the thumb keyboard to fit their personal preferences.

A method for configuring a touchscreen keyboard of a display device is disclosed. The method includes receiving a sketched line from a user on a touchscreen of the display device. The method also includes rendering a keyboard area on the touchscreen of the display device based on characteristics of the sketched line. The keyboard area represents the touchscreen keyboard. The method further includes receiving a user input on the touchscreen, where the user input is a command to manipulate the touchscreen keyboard. The method further includes re-rendering the keyboard area that represents the touchscreen keyboard on the touchscreen based on the user input. The method further includes displaying the touchscreen keyboard in the keyboard area on the touchscreen.

An apparatus to configure a touchscreen keyboard is disclosed. The apparatus includes a touchscreen display configured to receive touchscreen input and to display the touchscreen keyboard. The apparatus includes a memory, and one or more processors that read the memory. The processors are configured to receive a sketched line on the touchscreen. The processors are also configured to render a keyboard area on the touchscreen based on characteristics of the sketched line. The keyboard area represents the touchscreen keyboard. The processors are further configured to receive a user input on the touchscreen, where the user input is a command to manipulate the touchscreen keyboard. The processors are further configured to re-render the keyboard area that that represents the touchscreen keyboard on the touchscreen based on the user input. The processors are further configured to display the touchscreen keyboard in the keyboard area on the touchscreen.

A non-transitory computer-readable medium that stores machine-readable instructions for execution by processors are disclosed. The processors read the instructions to perform steps for configuring a touchscreen keyboard. The instructions include steps to receive a sketched line on a touchscreen of a display device. The instructions further include steps to render a keyboard area on the touchscreen of the display device based on characteristics of the sketched line. The keyboard area represents the touchscreen keyboard. The instructions further include steps to receive a user input on the touchscreen, where the user input is a command to manipulate the touchscreen keyboard. The instructions further include steps to re-rendering the keyboard area that represents the touchscreen keyboard on the touchscreen based on the user input. The instructions further include steps to display the touchscreen keyboard in the keyboard area on the touchscreen.

A system for configuring a touchscreen keyboard of the system is disclosed. The system includes means for receiving a sketched line on a touchscreen of the system. The system also includes means for rendering a keyboard area on the touchscreen of the system based on characteristics of the sketched line. The keyboard area represents the touchscreen keyboard. The system further includes means for receiving a user input on the touchscreen, where the user input is a command to manipulate the touchscreen keyboard. The system further includes means for re-rendering the keyboard area that represents the touchscreen keyboard on the touchscreen based on the user input. The system further includes means for displaying the touchscreen keyboard in the keyboard area on the touchscreen.

### BRIEF DESCRIPTION OF THE DRAWINGS

FIG. 1 shows a user holding a mobile device in the palm of one hand and typing on the thumb keyboard on the touchscreen using the thumb of the same hand according to one embodiment of the subject matter of the present disclosure;

FIG. 2 shows a flowchart of a process for mobile devices to allow users to create and customize a thumb keyboard on the touchscreen according to one embodiment of the subject matter of the present disclosure; and

FIG. 3 shows a display of a thumb keyboard that illustrates various ways that users may manipulate the touchscreen to create and customize the keyboard according to one embodiment of the subject matter of the present disclosure; and

FIG. 4 is a block diagram of a computer system suitable for implementing the thumb keyboard on the touchscreen according to one embodiment of the subject matter of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed for deformable thumb keyboards on the touchscreens of mobile devices to enable users to use the thumb of the same hand that is holding a mobile device to type on the keyboard of the mobile device. Users may enter a keyboard configuration mode of the mobile device to create and fine tune the thumb keyboard. To create a thumb keyboard, users may sketch an arc on the touchscreen to define a general outline of the keyboard. Users may manipulate the shape, size, location, layout, etc., of the thumb keyboard on the touchscreen to fit the users' preferences. For example, a right-handed user may customize a thumb keyboard in an arc region along the lower right corner of the touch screen to allow the right thumb of the user easy access to all the keys when holding the mobile device in the right hand. Advantageously users may effortlessly use the thumb of the hand holding the mobile device to compose e-mails/text messages, enter website URLs, or type commands into programs running on the mobile device.

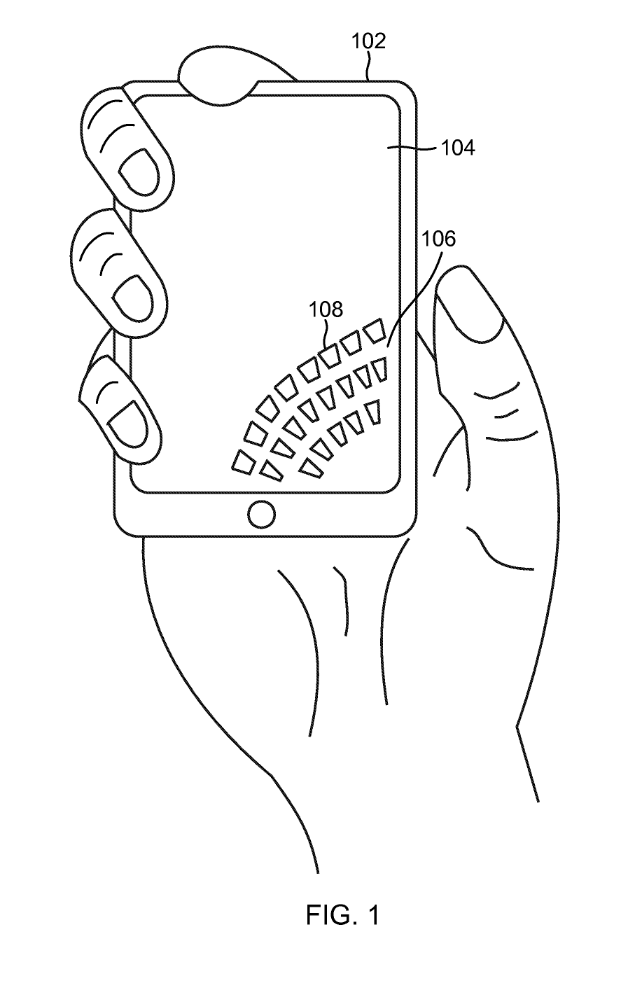

FIG. 1 shows a user holding a mobile device in a portrait orientation with a right hand and having access to a thumb keyboard on the touchscreen of the mobile device from the right thumb according to one embodiment of the subject matter of the present disclosure. A mobile device 102 may be a smartphone (e.g., iPhone, Google phone, or other phones running Android, Window Mobile, or other operating systems), a tablet computer (e.g., iPad, Galaxy), a personal digital assistant (PDA), a notebook computer, or various other types of wireless or wired computing devices. It should be appreciated that mobile device 102 may be referred to as a computing device without departing from the scope of the present disclosure. Mobile device 102 may communicate over a network with other devices.

Mobile device 102 has a touchscreen 104 on which is displayed a thumb keyboard 106. Thumb keyboard 106 has rows of keys spread out in arcs near the lower right corner of touchscreen 104. The user may configure the features of thumb keyboard 106 such as its shape, size, location, etc., to enable the thumb to ergonomically touch all the keys with ease. For example, if the thumb pivots from a spot slightly above the lower right corner of touchscreen 104 as shown, an outer row of keys 108 may be displayed in an arc from a height even with the tip of the thumb on the right edge of the touchscreen to a point near the center bottom of the touchscreen. The distance from the outer row of keys 108 to the lower right corner of touchscreen 106 may be slightly less than the length of the thumb. The region near the lower right corner of touchscreen 106 may not have keys so the user does not need to curl the thumb at an awkward angle to reach the inner rows of the keys.

To configure thumb keyboard 106, users may enter a configuration mode of a keyboard display program on mobile device 102. Users may sketch a rough arc on touchscreen 104 near the lower right region to quickly define a general outline of thumb keyboard 106. The keyboard display program may create a preliminary outline of thumb keyboard 106 whose outer edge, inner edge, or bisecting arc aligns with the sketched arc. For example, mobile device 102 may display on touchscreen 104 a boundary of thumb keyboard 106. The keyboard boundary may be defined by an outer arc, an inner arc in parallel with the outer arc, and lines connecting the two end points of the outer arc with the respective end points of the inner arc.

To fine tune thumb keyboard 106, users may drag the arcs, lines, or vertices of the keyboard boundary to the desired location on touchscreen 104 to change the size or the shape of thumb keyboard 106. In one or more embodiments, touchscreen 106 may highlight program-defined move points on the keyboard boundary for users to manipulate to fine tune thumb keyboard 106. In one or more embodiments, users may move thumb keyboard 106 without changing the shape of the keyboard, also known as a translation, by dragging any point interior to the keyboard boundary to a new location. When users are satisfied with the shape, size, and position of the keyboard boundary, user may invoke the keyboard display program to populate the keys into the area enclosed by the keyboard boundary. In one or more embodiments, users may reposition individual keys by dragging a key to its desired location. Thus, users may customize thumb keyboard 106 to enable users to access all the keys ergonomically using the thumb of the hand holding mobile device 102. In one or more embodiments, users may sketch a second line to divide thumb keyboard 106 into two partitions. Users may fine tune each keyboard partition in the same manner as described to enable users to type with both thumbs if desired.

After users have customized thumb keyboard 106 to their liking, users may save the layout of thumb keyboard 106. Users may retrieve thumb keyboard 106 for subsequent uses or for further customization. In one or more embodiments, thumb keyboards may be customized for each thumb of a user, or for different users of mobile device 102.

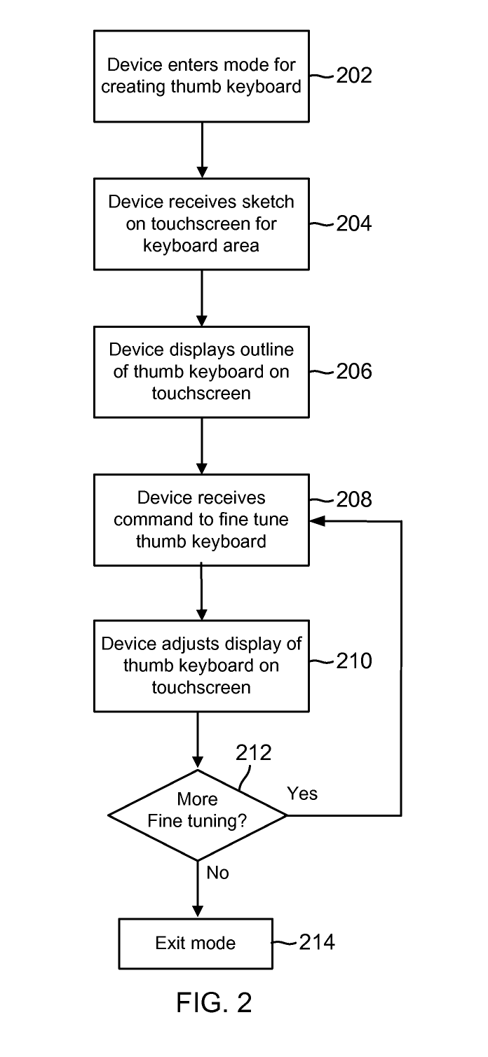

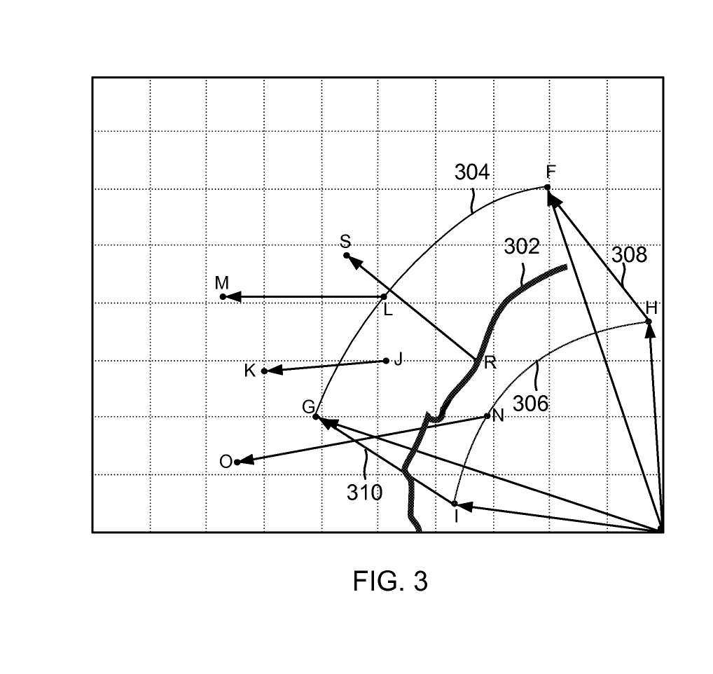

FIG. 2 shows a flowchart of a process for a mobile device to allow a user to create and customize a thumb keyboard on a touchscreen according to one embodiment of the subject matter of the present disclosure. The process of FIG. 2 may be implemented as a keyboard display program that the user may invoke on mobile device 102 to create and customize the thumb keyboard. FIG. 3 shows a display of a thumb keyboard that illustrates various ways that a user may manipulate the touchscreen to create and customize the keyboard according to one embodiment of the subject matter of the present disclosure. FIG. 3 will be discussed in conjunction with FIG. 2.

In 202, a user invokes the keyboard display program on mobile device 102. To create a new thumb keyboard, users may enter a create mode of the program to create thumb keyboard 106. In 204, the user sketches a rough arc on touchscreen 104 to define a general region for thumb keyboard 106. The user may sketch the arc with the thumb from a position in which user may expect to use thumb keyboard 106. The keyboard display program detects the sketch and renders the arc on the touchscreen. In 206, the keyboard display program uses the sketched arc to render a boundary of thumb keyboard 106 on touchscreen 104.

In one or more embodiments, the keyboard display program may align an outer edge of the keyboard boundary with the sketched arc. The keyboard display program may render the outer edge as well as an inner edge to display a keyboard boundary with a default area and shape. Thus, the user may sketch the arc to define an outer reach of the thumb to delimit the outer edge of thumb keyboard 106. In one or more embodiments, the user may sketch a second arc to define an inner reach of the thumb. The keyboard display program may align an inner edge of the keyboard boundary with the second arc. Thus, the user may sketch two arcs to conveniently delimit the outer edge and the inner edge of thumb keyboard 106. In one or more embodiments, after the user sketches a single arc, the keyboard display program may render a keyboard boundary enclosing an area that is approximately bisected by the sketched arc. Thus, the user may sketch the arc to define the bisecting arc of thumb keyboard 106.

Referring to FIG. 3, a sketched arc 302 drawn by the user is shown. From sketched arc 302, the keyboard display program renders a keyboard boundary defined by an outer arc 304 connecting points F and G, an inner arc 306 connecting point H and I, a lower radial line 310 connecting point G and I, and an upper radial line 308 connecting point F and H. Points F, G, H, and I form the four vertices of the keyboard boundary. Outer arc 304 and inner arc 306 have approximately the same curvature as sketched arc 302 and have arc lengths that are approximately the same as the length of sketched arc 302. In one or more embodiments, if a sketched arc is used as the outer edge of thumb keyboard 106, outer arc 304 may align with sketched arc 302. In other embodiments, when a first sketched arc defines the outer edge of thumb keyboard 106, the user may sketch a second arc to define the inner edge of thumb keyboard 106. Thus, inner arc 306 may align with the second sketched arc. In yet other embodiments, the first sketched arc defines the inner edge of thumb keyboard 106. Thus, inner arc 306 may align with sketched arc 302. When only one sketched arc is used to generate the keyboard boundary, the keyboard display program may generate a default area for thumb keyboard 106 enclosed by the keyboard boundary. In FIG. 3, sketched arc 302 is used by the keyboard display program to approximately bisect this default area for thumb keyboard 106. In one or more embodiments, the keyboard display program may populate the area enclosed by the keyboard boundary with keys of thumb keyboard 106. The keys may be spread out in rows that are parallel to outer arc 304 and/or inner arc 306 in a layout similar to an arrangement of seats in an amphitheater.

Once the keyboard display program renders the keyboard boundary, the user may further configure the keyboard boundary to customize thumb keyboard 106. The user may drag arcs, lines, vertices, or interior points of the keyboard boundary to the desired location on touchscreen 104 to change the size, shape, or location of thumb keyboard 106. In one or more embodiments, touchscreen 106 may highlight defined move points located on, and/or within, the keyboard boundary for the user to manipulate the keyboard boundary. The user may manipulate one or more of the move points to customize the keyboard boundary. Referring back to FIG. 2, in 208, the keyboard display program detects user manipulation of the keyboard boundary entered on touchscreen 104. The keyboard display program determines from the user manipulation the intended action. For example, the keyboard display program may determine that the user intends to reposition an arc of the keyboard boundary when the user drags a point on the arc to a new position. In another example, the keyboard display program may determine that the user intends to relocate thumb keyboard 106 when the user drags a point in the interior of the keyboard boundary to a new position. In 210, the keyboard display program renders an updated keyboard boundary on touchscreen 104. The keyboard display program may update the display of the keys of thumb keyboard 106 in accordance with the updated keyboard boundary. The user may manipulate the keyboard boundary until the user is satisfied with the layout of the keyboard boundary. In 212, the keyboard display program determines if there is additional user manipulation of the keyboard boundary. If there is additional user manipulation, the keyboard display program repeats 208 and 210. If the user is satisfied with the keyboard boundary, the user may exit the create mode of the keyboard display program in 214. In one or more embodiments, the keyboard display program may not populate the keys of thumb keyboard 106 until after the user is satisfied with the keyboard boundary. The user may reposition the locations of keys from their default locations. In one or more embodiments, the user may save the customized thumb keyboard 106 for later retrieval. After the user exits the create mode, the user may proceed to type on keys of thumb keyboard 106.

Referring back to FIG. 3, to change the length of outer arc 304, or to reposition the endpoint of outer arc 304, the user may drag point F or point G. For example, the user may drag point G to a new position away from point F to lengthen outer arc 304 to increase the area of thumb keyboard 106. As the user's thumb drags point G away point from F, point F may remain anchored, and outer arc 304 may flex to extend from point F to the new position of point G. Similarly, point I may remain anchored and lower radial line 310 may stretch to extend from point I to the new position of G. In one or more embodiments, when the user drags point G, point I may track the new position of G to maintain the approximate parallel relationship between inner arc 306 and outer arc 304. The user may similarly drag point F to change the length of outer arc 304 or to reposition an endpoint of outer arc 304. Similarly, the user may drag points H or I to change the length of, or the endpoints of inner arc 306. In one or more embodiments, when the user drags points H or I, points F or G may track the movement of points H or I to keep inner arc 306 and outer arc 304 approximately in parallel.

To change the curvature of an arc, the user may drag a point on the arc that is not an endpoint to a new position. For example, the user may drag point L on outer arc 304 to location M to change the curvature of outer arc 304. The endpoints of outer arc 304, point F and point G, may remain anchored, but outer arc 304 may pass through location M to increase the curvature of outer arc 304. In one or more embodiments, as the curvature of outer arc 304 changes, the curvature of inner arc 306 may also change to keep the outer arc 304 and inner arc 306 approximately in parallel. In one or more embodiments, when point L moves to position M, the endpoint furthest from point L, point F, remains anchored. However, the endpoint closer to point L, point G, may track the movement of point L to reduce the change in curvature that would otherwise result if both endpoints remain anchored. Thus, moving a non-endpoint of an arc may be another way to move the endpoint of the arc. In one or more embodiments, as point G moves to track the movement of point L, point I may also track the movement of G to maintain the approximate parallel relationship between inner arc 306 and outer arc 304. In one or more embodiments, when the user drags point L to position M, both points F and G may track the movement of point L to maintain the shape of outer arc 304. Thus, the user may reposition an arc, also known as a translation, by dragging a non-endpoint on the arc. In one or more embodiments, a translation of outer arc 304 may induce a translation of inner arc 306. Similarly, the user may drag point N of inner arc 306 to position O to change the shape of, to move the endpoint of, or to effect a translation of inner arc 306. The user may similarly drag non-endpoints of higher radial line 308 or lower radial line 310 to manipulate the shape, size, or position thereof.

Points L and N may be defined move points that are associated with specific types of manipulation of outer arc 304 and inner arc 306, respectively. For example, point L may be a move point associated with changing the shape of outer arc 304, e.g., moving L will keep points F and G anchored. Point N may be a move point associated with translating inner arc 306, e.g., moving N will move both points F and G. In one or more embodiments, rather than manipulating defined move points, the user may drag any non-endpoint on outer arc 304 or inner arc 306 to manipulate the arcs in a specific way e.g., to change the curvature with both endpoints anchored, to change the curvature with one endpoint anchored, or to translate, etc. The keyboard display program may define the default manipulation associated with dragging any non-endpoints on an arc. In one or more embodiments, the keyboard display program may provide options for the user to change the default manipulation. Manipulating the keyboard boundary may change the area of thumb keyboard 106. The keyboard display program may reposition the keys of thumb keyboard 106 in accordance with the changed area to uniformly distribute the keys.

To translate the entire thumb keyboard 106 without changing its shape, the user may drag a defined move point J. For example, when the user drags point J to position K, all the points on the keyboard boundary may linearly translate as defined by the vector \vec{JK}. In one or more embodiments, the user may drag any point enclosed within the keyboard boundary to translate thumb keyboard 106. In one or more embodiments, the user may rotate thumb keyboard 106 by touching any two points enclosed within the keyboard boundary and rotating one point about the other point. In addition to customizing the shape, size, and/or size of the keyboard boundary, the user may customize the location of keys of thumb keyboard 106. For example, the user may drag a frequently used key to a location that may be most easily accessed by the thumb. Thus, the user may customize thumb keyboard 106 to fit the user's preferences. In one or more embodiments, the user may position thumb keyboard 106 to be on the side of mobile device 102 opposite from the thumb. Thus, the user may access keys with a non-thumb finger while holding a smartphone close to the ear to use the phone function. For example, the user may use the index finger to key in commands on the keyboard in a call session with an interactive voice response system without lifting the smartphone from the listening ear.

In one or more embodiments, the user may split thumb keyboard 106 into two partitions that are positioned on opposite sides of mobile device 102. For example, the user may sketch a line to partition the keyboard boundary into two partitions. One partition may remain in its current position, and the other partition may be re-positioned to the opposite side of mobile device 102 to minor the position of the first partition. In one or more embodiments, the user may sketch an arc on opposite sides of mobile device 102 to define the preliminary outline of the two partitions of thumb keyboard 106. The user may customize the keyboard boundary for each partition of thumb keyboard 106 in the same manner as described. Thus, the user may conveniently type with both thumbs while holding mobile device 102 with both hands in a landscape orientation.

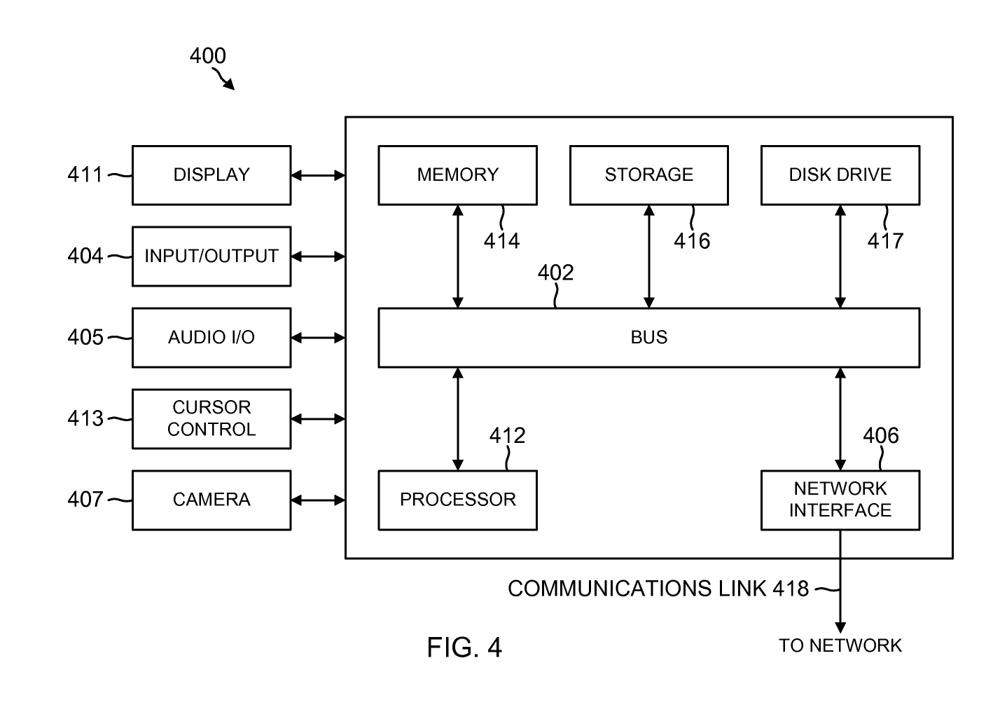

FIG. 4 is a block diagram of a computer system 400 suitable for implementing mobile device 102 of FIG. 1 according to one embodiment of the subject matter of the present disclosure. Mobile device 102 may comprise or implement a plurality of hardware components and/or software components that operate to perform various methodologies in accordance with the described embodiments. Mobile device 102 may include, for example, stand-alone and networked computers running mobile OS.

Computer system 400 includes a bus 402 or other communication mechanism for communicating data, signals, and information between various components of computer system 400. Components include an input/output (I/O) component 404 that processes a user action, such as detecting the user creating and manipulating a touchscreen keyboard, typing on a touchscreen keypad/keyboard, selecting one or more buttons or links, etc., and sends a corresponding signal to bus 402. I/O component 404 may also include an output component such as a touchscreen display 411, an input component such as a camera 407, and an input control such as a cursor control 413 (such as a virtual keyboard, virtual keypad, virtual mouse, etc.). An optional audio input/output component 405 may also be included to allow a user to use voice for inputting information by converting audio signals into information signals. Audio I/O component 405 may allow the user to hear audio. A transceiver or network interface 406 transmits and receives signals between computer system 400 and other devices, such as another user device, or another network computing device via a communication link 418 to a network. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical, or magnetic disks, or solid-state drives, such as storage component 416 or disk drive 417; volatile media includes dynamic memory, such as system memory component 414; and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

For example, instructions for the keyboard display program to create and manipulate the touchscreen keyboard as described may be stored in the computer readable medium of system memory component 414, storage component 416, or disk drive 417 for execution by processor 412. Processor 412 may execute the instructions to create the keyboard boundary to align with a sketched arc or to change the touchscreen keyboard based on manipulations of the keyboard boundary. Processor 412 may execute the instructions so that a user may configure the touchscreen keyboard to enable typing with the thumb of the hand that is holding computer system 400.

Where applicable, various embodiments provided by the present disclosure may be implemented using hardware, software, firmware, or combinations thereof. Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

For example, computer system 400 may include tactile sensors in display 411 and sensor software executed by processor 412 to detect the sketched arc or the manipulation of the keyboard boundary entered by a user on the touchscreen of display 411. Computer system 400 may include a hardware graphic coprocessor working in conjunction with software executed by processor 412 to render the touchscreen keyboard on display 411 based on detected user commands.

Although embodiments of the present disclosure have been described, these embodiments illustrate but do not limit the disclosure. For example, although configuration of thumb keyboards is illustrated for touchscreens of mobile devices, embodiments of the present disclosure may encompass configuration of other types of user interface, such as icons, menus, etc. for touchscreens of any communication or computer devices. It should also be understood that although manipulation of the thumb keyboard is illustrated by users manipulating the keyboard boundary on the touchscreens, embodiments of the present disclosure may encompass users entering manipulation commands using voice or other types of user interface etc. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method for configuring a touchscreen keyboard of a display device, comprising:
receiving a sketched line from a user on a touchscreen of the display device;
rendering a keyboard area on the touchscreen of the display device based on characteristics of the sketched line, wherein the keyboard area represents the touchscreen keyboard;
receiving a user input on the touchscreen, wherein the user input is a command to manipulate the touchscreen keyboard;
re-rendering the keyboard area that represents the touchscreen keyboard on the touchscreen based on the user input; and
displaying the touchscreen keyboard in the keyboard area on the touchscreen.

2. The method of claim 1, wherein said rendering a keyboard area on the touchscreen of the display device based on characteristics of the sketched line comprises using a position of the sketched line to define a boundary of the keyboard area.

3. The method of claim 2, wherein the boundary of the keyboard area aligns with the sketched arc.

4. The method of claim 2, wherein an outer boundary and an inner boundary of the keyboard area are parallel to the sketched arc, and wherein the sketched arc approximately bisects the keyboard area.

5. The method of claim 1, wherein the keyboard area displays one or more move points, wherein each move point is associated with a manipulation of the touchscreen keyboard.

6. The method of claim 5, wherein said receiving a user input on the touchscreen comprises detecting a movement of one of the move points to a new position.

7. The method of claim 6, wherein the move point is associated with changing a boundary of the keyboard area, and wherein said re-rendering the keyboard area based on the user input comprises changing the boundary of the keyboard area to the new position of the move point.

8. The method of claim 6, wherein the move point is associated with translating the keyboard area, and wherein said re-rendering the keyboard area based on the user input comprises linearly translating the keyboard area by a vector from an old position of the move point, before the movement of the move point, to the new position of the move point.

9. The method of claim 1, wherein said displaying the touchscreen keyboard in the keyboard area comprises populating the keyboard area with keys of the touchscreen keyboard.

10. The method of claim 1, wherein the keyboard area defines an area accessible by a thumb of a hand of the user holding the display device.

11. An apparatus, comprising:
A touchscreen display configured to receive touchscreen input and to display a touchscreen keyboard;
a memory; and
one or more processors coupled to the memory and configured to:
receive a sketched line on the touchscreen;
render a keyboard area on the touchscreen based on characteristics of the sketched line, wherein the keyboard area represents the touchscreen keyboard;
receive a user input on the touchscreen, wherein the user input is a command to manipulate the touchscreen keyboard;
re-render the keyboard area that that represents the touchscreen keyboard on the touchscreen based on the user input; and
display the touchscreen keyboard in the keyboard area on the touchscreen.

12. The apparatus of claim 11, wherein the one or more processors configured to render a keyboard area on the touchscreen based on characteristics of the sketched line comprises the processors configured to use a position of the sketched line to define a boundary of the keyboard area.

13. The apparatus of claim 12, wherein the boundary of the keyboard area aligns with the sketched arc.

14. The apparatus of claim 12, wherein an outer boundary and an inner boundary of the keyboard area are parallel to the sketched arc, and wherein the sketched arc approximately bisects the keyboard area.

15. The apparatus of claim 11, wherein the keyboard area displays one or more move points, wherein each move point is associated with a manipulation of the touchscreen keyboard.

16. The apparatus of claim 15, wherein the one or more processors configured to receive a user input on the touchscreen comprises the processors configured to detect a movement of one of the move points to a new position.

17. The apparatus of claim 16, wherein the move point is associated with a change to a boundary of the keyboard area, and wherein the one or more processors configured to re-render the keyboard area based on the user input comprises the processors configured to change the boundary of the keyboard area to the new position of the move point.

18. The apparatus of claim 16, wherein the move point is associated with a translation of the keyboard area, and wherein the one or more processors configured to re-render the keyboard area based on the user input comprises the processors configured to linearly translate the keyboard area by a vector from an old position of the move point, before the movement of the move point, to the new position of the move point.

19. The apparatus of claim 11, wherein the one or more processors configured to display the touchscreen keyboard in the keyboard area on the touchscreen comprises the processors configured to populate the keyboard area with keys of the touchscreen keyboard.

20. The apparatus of claim 11, wherein the keyboard area defines an area accessible by a thumb of a hand of a user holding the apparatus.

21. A non-transitory computer-readable medium comprising a plurality of machine-readable instructions which, when executed by one or more processors, are adapted to cause the one or more processors to perform a method comprising:
receiving a sketched line on a touchscreen of a display device;
rendering a keyboard area on the touchscreen of the display device based on characteristics of the sketched line, wherein the keyboard area represents a touchscreen keyboard;
receiving a user input on the touchscreen, wherein the user input is a command to manipulate the touchscreen keyboard;
re-rendering the keyboard area that represents the touchscreen keyboard on the touchscreen based on the user input; and
displaying the touchscreen keyboard in the keyboard area on the touchscreen.

22. The non-transitory computer-readable medium of claim 21, wherein said rendering a keyboard area on the touchscreen of the display device based on characteristics of the sketched line comprises using a position of the sketched line to define a boundary of the keyboard area.

23. The non-transitory computer-readable medium of claim 21, wherein the keyboard area displays one or more move points, wherein each move point is associated with a manipulation of the touchscreen keyboard.

24. The non-transitory computer-readable medium of claim 23, wherein said receiving a user input on the touchscreen comprises detecting a movement of one of the move points to a new position.

25. A system for configuring a touchscreen keyboard of the system, comprising:
means for receiving a sketched line on a touchscreen of the system;
means for rendering a keyboard area on the touchscreen of the system based on characteristics of the sketched line, wherein the keyboard area represents the touchscreen keyboard; and
means for receiving a user input on the touchscreen, wherein the user input is a command to manipulate the touchscreen keyboard;
means for re-rendering the keyboard area that represents the touchscreen keyboard on the touchscreen based on the user input; and
means for displaying the touchscreen keyboard in the keyboard area on the touchscreen.

26. The system of claim 25, wherein the means for rendering a keyboard area on the touchscreen of the system based on characteristics of the sketched line comprises means for using a position of the sketched line to define a boundary of the keyboard area.

27. The system of claim 25, wherein the keyboard area displays one or more move points, wherein each move point is associated with a manipulation of the touchscreen keyboard.

28. The system of claim 27, wherein the means for receiving a user input on the touchscreen comprises means for detecting a movement of one of the move points to a new position.
